(19) United States
(12) Patent Application Publication
(10) Pub. No.: US 2023/0346097 A1
(43) Pub. Date: Nov. 2, 2023

(54) Pressing transmission device and curler

(71) Applicant: Shenzhen FENDA Technology Co., LTD, Shenzhen (CN)

(72) Inventors: Mianjia Wei, Shenzhen (CN); Sanping Zhang, Shenzhen (CN)

(21) Appl. No.: 18/338,490

(22) Filed: Jun. 21, 2023

(30) Foreign Application Priority Data
Jun. 22, 2022 (CN) 202210711428.1

(51) Int. Cl. A45D 6/04

(52) U.S. Cl. CPC A45D 6/04; A45D 1/04

(57) ABSTRACT

The invention relates to hairdressing equipment and discloses a pressing transmission device and curler. The pressing transmission device comprises a housing assembly, a movable or rotatable pressing assembly in the housing, a connecting rod assembly having a first moving end connected to the pressing assembly, driven by it, and a second moving end connected to a reversing assembly. The reversing assembly has a moving part connected to the second moving end and a rotating part matched with the moving part, which converts the movement of the connecting rod assembly into the rotation of the rotating part. The connecting rod assembly and the reversing assembly are both provided in the housing assembly. The structure of the pressing transmission device provided is simple, and the rotation of the rotating part can be achieved by pressing the pressing assembly, which is convenient in operation.

### TECHNICAL FIELD

The present invention pertains to the technical field of hairdressing equipment, and more particularly, to a pressing transmission device. Additionally, the present invention relates to a curler that includes the aforementioned pressing transmission device.

### BACKGROUND

The existing technology for hair curlers mainly includes two types: fully automatic curlers and manual curlers. Fully automatic curlers can achieve automatic curling with good styling effects and sound prompts for status monitoring. However, they are generally bulky, large in size, noisy, with poor durability of hairstyle, easy to get hair stuck, high in price, and with control buttons that are prone to accidental operation and difficult to clean. On the other hand, manual curlers are lightweight and compact, with good curling styling effects, but they are noisy and require high technical skills for the operator. Besides, they can cause hand fatigue during use, and the durability of the hairstyle is poor.

Therefore, it is an urgent problem for professionals in this field to provide a structurally simple pressing transmission device.

### SUMMARY OF THE INVENTION

Given the above, the purpose of this invention is to provide a pressing transmission device that is simple in structure and easy to use, which drives the rotating part of the reversing assembly through the connecting rod assembly.

Another objective of this invention is to provide a hair curler that includes the above-mentioned pressing transmission device.

To achieve the above objectives, the present invention provides the following technical solution:

A pressing transmission device comprising:

A housing assembly;

A pressing assembly that is movable or rotatable along the pressing direction and is set in the housing assembly;

A connecting rod assembly, whose first moving end is connected to the pressing assembly and is driven by the pressing assembly, and whose second moving end is connected to the reversing assembly;

The reversing assembly, which is provided with a moving part connected to the second moving end and a rotating part that cooperates with the moving part, and is used to convert the movement of the connecting rod assembly into the rotation of the rotating part;

The connecting rod assembly and the reversing assembly are both set in the housing assembly.

Optionally, the fixed end of the connecting rod assembly is set in the housing assembly.

Optionally, the connecting rod assembly includes a first connecting rod, a second connecting rod, and a third connecting rod. One end of the first connecting rod is rotatably connected to the reversing assembly, and the other end is rotatably connected to the second connecting rod. The other end of the second connecting rod is rotatably connected to the housing assembly. One end of the third connecting rod is rotatably connected to the pressing part, and the other end is rotatably connected to a non-terminal position of the second connecting rod.

When the third connecting rod is driven by the pressing part to move, the first connecting rod drives the moving part of the reversing assembly, thereby causing the rotating part to rotate.

Optionally, the moving part is a toothed rack connected to the first connecting rod, and the rotating part includes a gear that engages with the toothed rack.

Optionally, the pressing assembly includes a pressing body, one end of which is rotatably connected to the housing assembly, and the other end is rotatably connected to the first moving end of the connecting rod assembly.

Optionally, the housing assembly includes a fixed part and a torsion spring, one end of the torsion spring abuts against the pressing body, and the other end abuts against the fixed part.

Optionally, the pressing assembly includes a pressing body and a translational guiding member. The pressing body can be movably positioned relative to the housing assembly along the translational guiding member, which is fixedly mounted on the housing assembly.

Optionally, the housing assembly is provided with a slide groove, and an elastic resetting member is installed in the slide groove. The moving part is slidably set in the slide groove;

One end of the elastic resetting member abuts against the slide groove, and the other end abuts against the moving part.

Optionally, the elastic resetting member is a spring, and the moving part is provided with a protrusion facing one side of the slide groove. One end of the spring abuts against the slide groove, and the other end abuts against the protrusion.

A curler comprising a curling part and any one of the above-mentioned pressing transmission devices, wherein the rotating part drives the curling part to rotate, and the housing assembly is a handle housing.

In the process of using the pressing transmission device provided by the present invention, firstly, the pressing assembly is pressed to make the pressing assembly move or rotate in the pressing direction. During the movement or rotation of the pressing assembly, the first moving end of the connecting rod assembly is driven to move or rotate. The movement or rotation of the first moving end drives the second moving end to move, and the movement of the second moving end drives the moving part to move, and the moving part drives the rotating part to rotate.

Compared with the prior art, the structure of the pressing transmission device provided by the present invention is simple, and the rotation of the rotating part can be achieved by pressing the pressing assembly, which is convenient to operate. The setting of the connecting rod assembly reduces the cost of the device, and the force transmission through the connecting rod is less lossy compared to the prior art, making it more efficient.

In addition, the present invention also provides a curler comprising the above-mentioned pressing transmission device.

### DESCRIPTION OF THE DRAWINGS

To provide a clearer explanation of the technical solutions in the embodiments or prior art of the present invention, a brief introduction will be given to the drawings that are necessary for describing the embodiments or prior art. The drawings described below are only embodiments of the present invention, and ordinarily skilled technicians in the field can obtain other drawings based on the provided drawings without exerting any creative efforts.

FIG. 1 shows an exploded view of a specific embodiment of the curler provided by the present invention;

FIG. 2 shows a sectional view of a specific embodiment of the curler provided by the present invention;

FIG. 3 shows a structural diagram of a specific embodiment of the pressing transmission device provided by the present invention;

FIG. 4 shows a side view of a specific embodiment of the pressing transmission device provided by the present invention;

FIG. 5 shows a schematic diagram of the position of the slide groove;

FIG. 6 shows a schematic diagram of a part of the structure of the curler provided by the present invention;

FIG. 7 shows a structural diagram of the curling part.

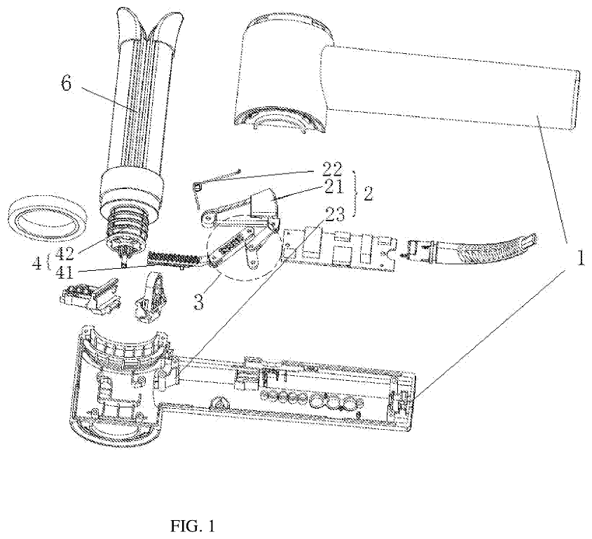

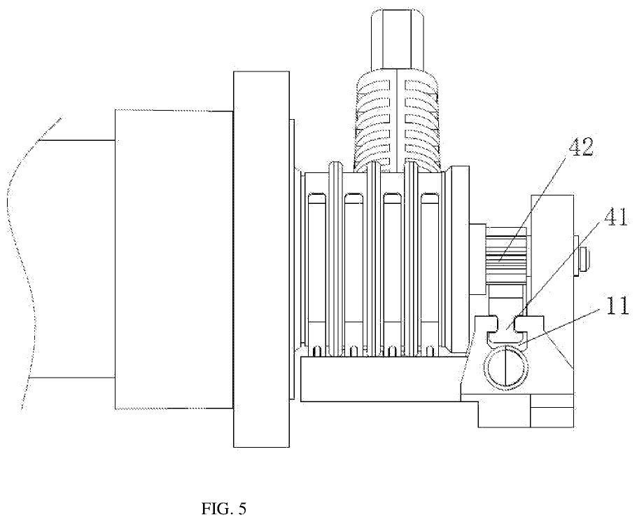

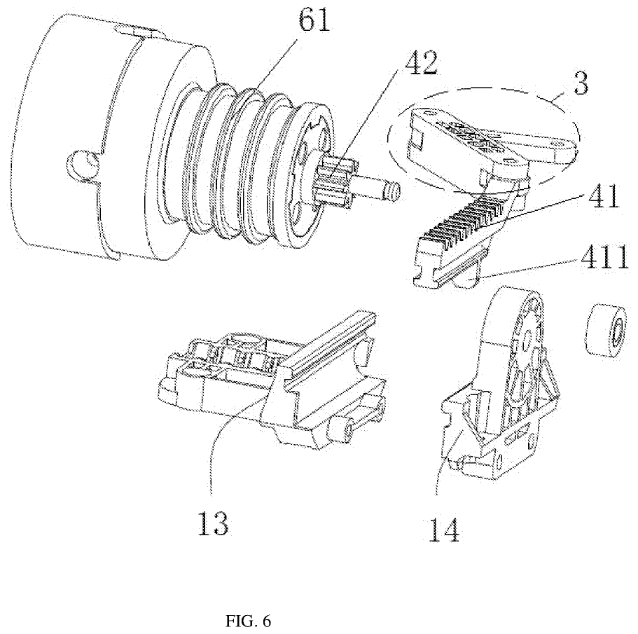

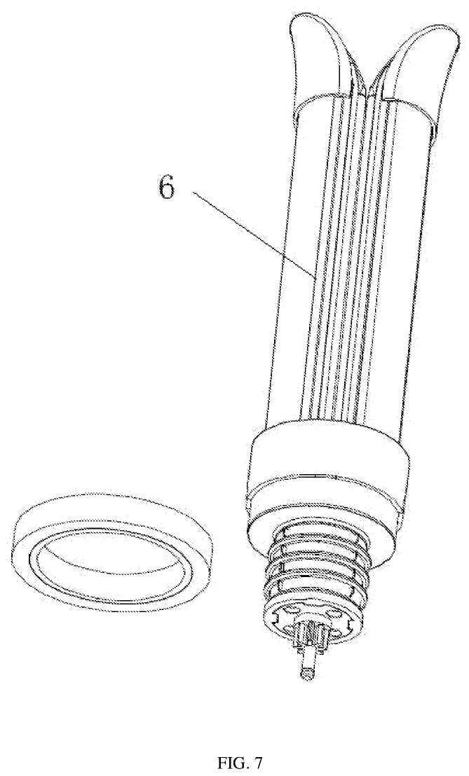

In FIGS. 1 to 7:

1. housing assembly, 11. slide groove, 12. spring, 13. positioning plate, 14. fixing seat, 2. pressing assembly, 21. pressing body, 22. torsion spring, 23. fixed part, 3. connecting rod assembly, 31. first connecting rod, 32. second connecting rod, 33. third connecting rod, 4. reversing assembly, 41. moving part, 411. protrusion, 42. rotating part, 5. hair, 6. curling part, 61. power supply assembly.

### DESCRIPTION OF THE EMBODIMENTS

The technology scheme in the embodiments of the invention will be described clearly and completely with reference to the accompanying drawings. It is evident that the embodiments described are only part of the embodiments of the invention, not all of them. Based on the embodiments of the invention, all other embodiments obtained by those skilled in the art without creative labor are within the scope of protection of the invention.

The core of the invention is to provide a pressing transmission device, which drives the rotating part of the reversing assembly through the connecting rod assembly, with a simple structure and ease to use.

Another core of the invention is to provide a curler including the above pressing transmission device.

Please refer to FIGS. 1-7.

The present embodiment discloses a pressing transmission device, comprising:

Housing assembly 1;

Pressing assembly 2, which can move or rotate along the pressing direction and is arranged on the housing 1 assembly 1;

Connecting rod assembly 3, whose first moving end is connected to the pressing assembly 2 and is driven by the pressing assembly 2, and whose second moving end is connected to the reversing assembly 4;

Reversing assembly 4, which is provided with a moving part 41 connected to the second moving end and a rotating part 42 that cooperates with the moving part 41, and is used to convert the movement of the connecting rod assembly 3 into the rotation of the rotating part 42;

Both the connecting rod assembly 3 and the reversing assembly 4 are arranged inside the housing assembly 1.

It should be noted that in the specific embodiment, the pressing assembly 2 can partially protrude from the housing assembly 1 or be completely located within the housing assembly 1. The housing assembly 1 is provided with a through-hole for pressing the pressing assembly 2, or other suitable setting methods can be determined according to actual conditions, which are not elaborated here.

The number and position of the connecting rods in the connecting rod assembly 3 need to be determined according to actual conditions.

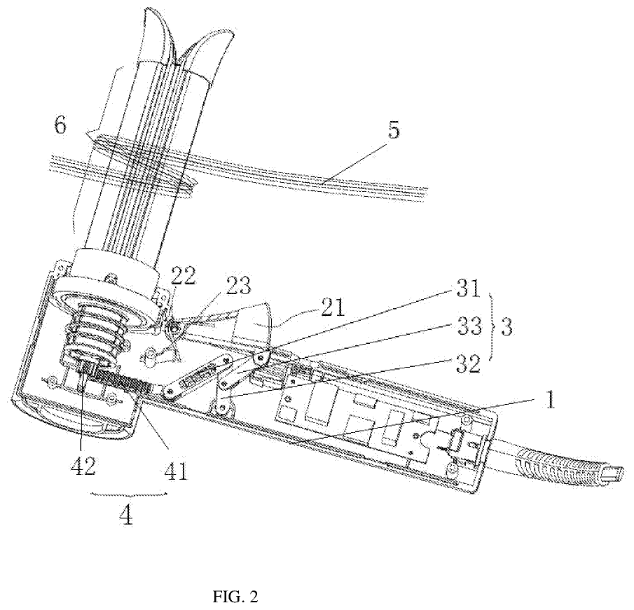

It should be noted that as shown in FIG. 2, the fixed end of the connecting rod assembly 3 in the specific embodiment can be set on the housing assembly 1. Of course, the fixed end of the connecting rod assembly 3 can also be directly set on the reversing assembly 4, which is determined according to actual conditions and is not elaborated here.

The reversing assembly 4 can be a worm gear structure, a gear rack structure, or other structures that meet the requirements, which are determined according to actual conditions and are not elaborated here.

In the process of using the pressing transmission device provided by the specific embodiment, first, press the pressing assembly 2 to make the pressing assembly 2 move or rotate in the pressing direction. During the movement or rotation of the pressing assembly 2, the first moving end of the connecting rod assembly 3 is driven to move or rotate, and the movement or rotation of the first moving end drives the second moving end to move. During the movement of the second moving end, the moving part 41 is driven to move, and the moving part 41 drives the rotating part 42 to rotate.

Compared with the prior art, the pressing transmission device provided by the specific embodiment has a simple structure and can achieve the rotation of the rotating part 42 by pressing the pressing assembly 2, which is convenient to operate. The setting of the connecting rod assembly 3 reduces the cost of the device, and the force transmission through the connecting rod is less lossy and more energy-efficient than the prior art.

As shown in FIG. 2, the connecting rod assembly 3 includes a first connecting rod 31, a second connecting rod 32, and a third connecting rod 33. One end of the first connecting rod 31 is rotatably connected to the reversing assembly 4, and the other end of the first connecting rod 31 is rotatably connected to the second connecting rod 32. The other end of the second connecting rod 32 is rotatably connected to the housing assembly 1. One end of the third connecting rod 33 is rotatably connected to the pressing part, and the other end of the third connecting rod 33 is rotatably connected to a non-terminal position of the second connecting rod 32.

When the third connecting rod 33 is driven by the pressing part, the first connecting rod 31 drives the moving part 41 of the reversing assembly 4 to move, so that the rotating part 42 rotates.

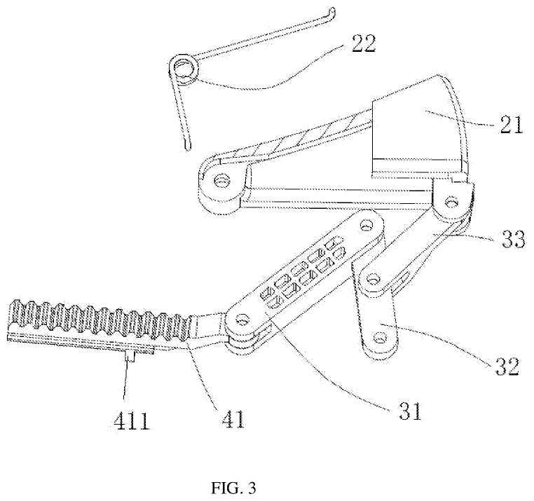

In the specific use process, as shown in FIGS. 2 and 3, the pressing assembly 2 is hinged to the housing assembly 1, and when the pressing assembly 2 is pressed, it drives one end of the third connecting rod 33 to rotate in the pressing direction. During the rotation of the third connecting rod 33, it drives the second connecting rod 32 to rotate around the hinge point hinged to the housing assembly 1. During the rotation of the second connecting rod 32, it drives one end of the third connecting rod 33 to move, and the third connecting rod 33 drives the reversing assembly 4 to move, thereby driving the rotating part 42 to rotate.

Compared with the prior art, the transmission part is set as the connecting rod assembly 3, and the connecting rod assembly 3 includes three connecting rods that are rotatably connected. In this specific embodiment, the rotational connection can be a hinged connection or other rotational connection methods that meet the requirements, which will be determined based on the actual situation. The structure of the connecting rod assembly 3 can be simplified, which further reduces the space occupied by the connecting rod assembly 3 and is conducive to the miniaturization of the pressing transmission device. In addition, the connecting rod has less power loss during the transmission of the pressing force of the pressing assembly 2, which can achieve a labor-saving effect.

In a specific embodiment, as shown in FIG. 2, the moving part 41 is a toothed rack connected to the first connecting rod 31, and the rotating part 42 includes a gear that meshes with the toothed rack. In the process of the connecting rod assembly 3 being driven by the pressing assembly 2, the movement of the toothed rack is driven, which in turn drives the rotation of the gear, thereby driving the rotation of the rotating part 42.

The setting of the gear and toothed rack can further improve the rotational accuracy of the rotating part 42.

In a specific embodiment, the pressing assembly 2 includes a pressing body 21, one end of which is rotatably connected to the housing assembly 1, and the other end is rotatably connected to the first moving end of the connecting rod assembly 3.

The housing assembly 1 is provided with a fixed part 23 and a torsion spring 22. One end of the torsion spring 22 abuts against the pressing body 21, and the other end abuts against the fixed part 23.

When there is no external force, the pressing body 21 extends out of the housing assembly 1 under the influence of the torsion spring 22. During the process of pressing the pressing body 21, the pressing body 21 overcomes the elastic force of the torsion spring 22 and moves towards the limit part, and in the process of movement, drives the first moving end of the connecting rod assembly 3 to move, so that the connecting rod assembly 3 drives the rotating part 42 to rotate, until the limit part of the gear shift adjustment assembly abuts. The setting of the torsion spring 22 can make the pressing body 21 automatically reset. The limit part here is a structure that limits the pressing stroke of the pressing body 21.

In a specific embodiment, the pressing assembly 2 includes the pressing body 21 and a translational guiding member. The pressing body 21 can be movably set relative to the housing assembly 1 along the translational guiding member, and the translational guiding member is fixedly provided on the housing assembly 1. The specific translational guiding member can be set as a slide rail structure, and the pressing assembly 2 can be slidably set along the translational guiding member.

Optionally, a reset spring can be provided, with one end of the reset spring abutting against the housing assembly 1 and the other end abutting against the pressing body 21. When there is no external force acting on it, the pressing body 21 is in a position away from the limiting part, which restricts the pressing stroke of the pressing body 21, under the action of the elastic force of the reset spring. During the process of pressing the pressing body 21, the pressing body 21 overcomes the elastic force of the reset spring to move towards the limiting part, and in the process of movement, drives the first moving end of the connecting rod assembly 3 to move, so that the connecting rod assembly 3 drives the rotating part 42 to rotate. This continues until the limiting part of the gear shift adjustment assembly abuts against it.

Specifically, in order to limit the movement direction of the pressing body 21, a slide rail extending along the pressing direction can be set in the housing assembly 1, and during the process of pressing the pressing body 21, the pressing body 21 slides along the slide rail.

The shift adjustment assembly mentioned in this specific embodiment is a structure for limiting the pressing stroke of the pressing assembly 2. Specifically, the shift adjustment assembly can be slidably arranged on the housing assembly 1, and has a limiting part that abuts and contacts the pressing assembly 2 to limit its pressing stroke. When the shift adjustment assembly slides to different positions relative to the housing assembly 1, the pressing stroke of the pressing assembly 2 is different, so that the transmission assembly drives the rotating part to rotate at different angles.

The sliding direction of the shift adjustment assembly relative to the housing assembly 1 can be perpendicular to the movement direction of the pressing assembly 2 relative to the housing assembly 1, or other directions, depending on the actual situation.

Specifically, in the process of sliding of the shift adjusting assembly relative to the housing assembly 1, the position of the limiting part will change. When the pressing assembly 2 is pressed against the limiting part, its stroke will also change, thus affecting the pressing stroke of the pressing assembly 2. This in turn affects the action of the connecting rod assembly 3 driven by the pressing assembly 2, and finally affects the rotation angle of the rotating part 42 driven by the connecting rod assembly 3.

Preferably, three-level steps can be set in the shift adjusting assembly, and the setting direction of the steps has a allowance along the moving direction of the pressing assembly 2. When the shift adjusting assembly slides relative to the housing assembly 1 to different positions during the pressing process of the pressing assembly 2, the pressing assembly 2 can be brought into contact with different steps.

In a specific embodiment, the housing assembly 1 is provided with a slide groove 11, in which an elastic resetting member is installed, and the moving part 41 can be slidably arranged in the slide groove 11.

One end of the elastic resetting member abuts against the slide groove 11, and the other end abuts against the moving part 41.

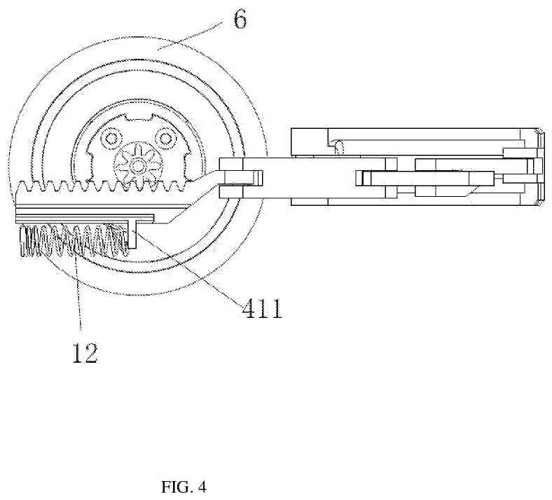

Specifically, the elastic resetting member can be set as a spring 12, and the moving part 41 is provided with a protrusion 411 towards one side of the slide groove 11, as shown in FIG. 4. One end of the spring 12 abuts against the slide groove 11, and the other end abuts against the protrusion 411. During use, the pressing assembly 2 drives the connecting rod assembly 3 to move, and the connecting rod assembly 3 drives the toothed rack to move. During the movement of the toothed rack, it overcomes the elastic force of the spring 12 and drives the gear to rotate. When the pressing assembly 2 is released, under the action of the spring 12, the toothed rack is pushed back to reset, and the pressing assembly 2 is driven to reset during the resetting process.

It should be noted that in this specific embodiment, the elastic resetting member can also be a spring sheet or other structures that meet the requirements, which can be determined according to the actual situation.

In addition to the above-mentioned pressing transmission device, the present invention also provides a curler comprising a curling part 6 and the pressing transmission device disclosed in the above embodiment. The structure of other parts of the curler can refer to the prior art and will not be described here.

In this specific embodiment, the curling part 6 includes a heating element and a power supply part 61 that supplies power to the heating element. The handle housing is provided with a positioning plate 13 that cooperates with the power supply part 61 and a fixed seat 14 that is fixedly connected to the positioning plate 13. The positioning plate 13 and the fixed seat 14 are surrounded by a slide groove 11, and the moving part 41 can be slidably arranged in the slide groove 11.

Specifically, the end of the curling part 6 is provided with a V-shaped opening for convenient entry of hair 5, thereby achieving curling.

The “first” and “second” in the first moving end, second moving end, the first connecting rod 31, the second connecting rod 32, and the third connecting rod 33 mentioned in this application are only used to distinguish different positions and do not have any order of precedence.

The various embodiments described in this manual are described progressively, with each embodiment focusing on the differences from other embodiments. The same or similar parts between the various embodiments can be referred to each other. Any combination of the embodiments provided by the present invention is within the scope of protection of this invention and is not repeated here.

The above has provided a detailed introduction to the pressing transmission device and curler provided by the present invention. Specific examples have been used to describe the principles and implementation methods of the present invention. The description of the embodiments is only intended to assist in understanding the method and core idea of the present invention. It should be pointed out that for those skilled in the art, various improvements and modifications can be made to the present invention without departing from the principles of the present invention, and these improvements and modifications are also within the scope of protection of the claims of the present invention.

What is claimed is:

1. A pressing transmission device, comprising:
a housing assembly;
a pressing assembly movably or rotatably arranged along the pressing direction on the housing assembly;
a connecting rod assembly, whose first moving end is connected to the pressing assembly and is driven to move by the pressing assembly, and whose second moving end is connected to a reversing assembly;
the reversing assembly is provided with a moving part connected to the second moving end and a rotating part cooperating with the moving part, and the reversing assembly is used to convert the movement of the connecting rod assembly into the rotation of the rotating part;
both the connecting rod assembly and the reversing assembly are arranged inside the housing assembly.

2. The pressing transmission device according to claim 1, wherein
the fixed end of the connecting rod assembly is located on the housing assembly.

3. The pressing transmission device according to claim 2, wherein
the connecting rod assembly comprises a first connecting rod, a second connecting rod, and a third connecting rod, one end of the first connecting rod is rotatably connected to the reversing assembly, and the other end of the first connecting rod is rotatably connected to the second connecting rod; the other end of the second connecting rod is rotatably connected to the housing assembly; one end of the third connecting rod is rotatably connected to the pressing part, and the other end of the third connecting rod is rotatably connected to a non-terminal position of the second connecting rod;
when the pressing part drives the third connecting rod to move, the first connecting rod drives the moving part of the reversing assembly to move, so as to rotate the rotating part.

4. The pressing transmission device according to claim 3, wherein
the moving part is a toothed rack connected to the first connecting rod, and the rotating part includes a gear meshing with the toothed rack for transmission.

5. The pressing transmission device according to claim 1, wherein
the pressing assembly comprises a pressing body, one end of which is rotatably connected to the housing assembly, and the other end is rotatably connected to the first moving end of the connecting rod assembly.

6. The pressing transmission device according to claim 5, wherein
the housing assembly is provided with a fixed part and a torsion spring inside, one end of which abuts against the pressing body, and the other end abuts against the fixed part.

7. The pressing transmission device according to claim 1, wherein
the pressing assembly includes a pressing body and a translation guiding assembly, the pressing body is movably set relative to the housing assembly along the translational guiding member, and the translational guiding member is fixedly arranged on the housing assembly.

8. The pressing transmission device according to claim 1, wherein
the housing assembly is provided with a slide groove, an elastic reset assembly is installed inside the slide groove, and the moving part is slidably set inside the slide groove;
one end of the elastic reset assembly abuts against the slide groove, and the other end abuts against the moving part.

9. The pressing transmission device according to claim 2, wherein
the housing assembly is provided with a slide groove, an elastic reset assembly is installed inside the slide groove, and the moving part is slidably set inside the slide groove;
one end of the elastic reset assembly abuts against the slide groove, and the other end abuts against the moving part.

10. The pressing transmission device according to claim 3, wherein
the housing assembly is provided with a slide groove, an elastic reset assembly is installed inside the slide groove, and the moving part is slidably set inside the slide groove;
one end of the elastic reset assembly abuts against the slide groove, and the other end abuts against the moving part.

11. The pressing transmission device according to claim 4, wherein
the housing assembly is provided with a slide groove, an elastic reset assembly is installed inside the slide groove, and the moving part is slidably set inside the slide groove;
one end of the elastic reset assembly abuts against the slide groove, and the other end abuts against the moving part.

12. The pressing transmission device according to claim 5, wherein
the housing assembly is provided with a slide groove, an elastic reset assembly is installed inside the slide groove, and the moving part is slidably set inside the slide groove;
one end of the elastic reset assembly abuts against the slide groove, and the other end abuts against the moving part.

13. The pressing transmission device according to claim 6, wherein
the housing assembly is provided with a slide groove, an elastic reset assembly is installed inside the slide groove, and the moving part is slidably set inside the slide groove;
one end of the elastic reset assembly abuts against the slide groove, and the other end abuts against the moving part.

14. The pressing transmission device according to claim 7, wherein
the housing assembly is provided with a slide groove, an elastic reset assembly is installed inside the slide groove, and the moving part is slidably set inside the slide groove;
one end of the elastic reset assembly abuts against the slide groove, and the other end abuts against the moving part.

15. The pressing transmission device according to claim 8, wherein
the elastic resetting member is a spring, the moving part is provided with a protrusion towards one side of the slide groove, one end of the spring abuts against the slide groove, and the other end abuts against the protrusion.
